(19) United States
(12) Patent Application Publication
(10) Pub. No.: US 2026/0070130 A1
(43) Pub. Date: Mar. 12, 2026

(54) CUTTING TOOL

(71) Applicant: Gühring KG, Albstadt (DE)

(72) Inventor: Jochen BITZER, Albstadt (DE)

(73) Assignee: Gühring KG, Albstadt (DE)

(21) Appl. No.: 19/324,056

(22) Filed: Sep. 9, 2025

(30) Foreign Application Priority Data
Sep. 10, 2024 (DE) 10 2024 125 972.8

(51) Int. Cl. B23B 27/10

(52) U.S. Cl. CPC B23B 27/10

(57) ABSTRACT

The present invention relates to a machining tool (30) with a shaft (8) extending along a tool axis (4), a cutting head (6) axially adjoining the shaft (8) and an internal cooling lubricant channel system formed from a centrally running inlet channel (12), which leads from an inlet opening (10) at the shaft end in the direction of the cutting head (6) all the way to a branch point (14), which lies at a defined axial distance from the inlet opening (10), at least one outlet channel (18) running in a decentralized manner, which leads to an outlet opening (20) on the cutting head front side, and a branch channel (16) running in a straight line, which branches off from the inlet channel (12) at the branch point (14) and which leads to the outlet channel (18) at a defined angle. A cross sectional surface of the at least one branch channel (16), which is projected along the at least one branch channel (16) in the direction of the shaft end, lies completely within the inlet opening (10).

The invention relates to a machining tool with a shaft extending along a tool axis, a cutting head axially adjoining the shaft and an internal cooling lubricant channel system.

The supply of a machining tool, e.g., of a drilling tool or of a milling tool, with cooling lubricant is of crucial importance for the success and the efficiency of machining processes. Cooling lubricants take over several important functions, which do not only significantly influence the quality of the processing but also the service life of the tool. On the one hand, the cooling lubricant contributes significantly to the cooling of the tool and of the workpiece. Significant amounts of heat, which lead to an overheating of the tool, are generated during the drilling or milling due to friction, whereby a wear can be accelerated and cutting edges can be damaged. The temperature is reduced by means of an effective cooling, which ensures a longer service life of the tool and simultaneously protects the workpiece against thermal damages. On the other hand, the cooling lubricant acts as lubricant, which reduces friction between the tool and the workpiece, whereby the cutting process is simplified and the required cutting force is decreased. The cooling lubricant can furthermore simplify the removal of the chips accumulating during the machining.

It is known from the prior art to carry out the supply of the cutting edges with cooling lubricant via a tool-internal cooling lubricant channel system. An internal cooling lubricant channel system can ensure that the cooling lubricant is guided directly to the cutting edges of the tool, whereby the above-described advantages can be ensured. An internal cooling lubricant channel system, on the other hand, increases the complexity of the tool construction. The channels have to be designed so that they efficiently guide the cooling lubricant to the cutting edges, without impacting the structural integrity of the tool. This requires advanced manufacturing techniques, such as, for instance, the deep hole drilling or additive manufacturing methods, e.g., 3D printing. On the other hand, the course of the channels should be designed so that the cooling lubricant can flow as unhindered as possible and without large pressure losses.

A twist drill with internal cooling channels is known from the publication DE 36 11 998 C2, which is made up of separately prefabricated parts, a cutting part with cutting edges and clamping grooves and a shaft part. The cutting part has two internal cooling channels, which run helically around the axis of rotation of the twist drill and which each end in an outlet opening on the front side of the twist drill. The shaft part comprises a central cooling channel with an inlet opening at one shaft end. In the assembled state of the twist drill, a cooling channel transition element is arranged between the front side of the cutting part facing away from the drill tip and a base of a recess of the shaft part for receiving the cutting part, which cooling channel transition element is connected in a fluid-tight manner to the shaft part as well as to the cutting part. In one embodiment, the cooling channel transition element has a branching, which establishes a connection from the central cooling channel of the shaft part to the helically running cooling channels in the cutting part via two cooling channel sections running at an angle to the axis of rotation.

The three-piece design of cutting part, cooling channel transition element and shaft part, which requires a seal between the elements, is disadvantageous in the case of the twist drill of the DE 36 11 998 C2. In addition, a precise manufacture of the cooling channels in the cutting part and cooling channel transition element on the one hand as well as a correct alignment of the cooling channel transition element relative to the cutting part is required at the interfaces between the elements in order to form flush or seamless transitions, respectively, between the cooling channel sections in the cooling channel transition element and the channels in the cutting part and to avoid flow losses.

The publication U.S. Pat. No. 1,409,753 A discloses a twist drill designed in two pieces with a cutting part and a shaft part as well as an internal cooling lubricant channel system. For this purpose, the cutting part has two cooling channels running parallel to an axis of rotation, which extend through the entire cutting part and which end in a front side of the twist drill. On the shaft side, the cooling channels are connected to one another via two channels, which run obliquely and which start at a branch point at the shaft-side end of the cutting part. The shaft part is screwed to the cutting part and comprises a centrally running inlet channel, which ends in the branch point in the assembled state of the twist drill.

Based on a twist drill, as it is known from the U.S. Pat. No. 1,409,753 A, the invention is based on the object of creating a machining tool with a shaft extending along a tool axis, a cutting head axially adjoining the shaft and an internal cooling lubricant channel system, which can be produced in a simple and cost-efficient manner. It is furthermore an object of the invention to provide a method for producing such a machining tool.

This object is solved by means of a machining tool with the features of claim 1, a machining tool with the features of claim 4, a method for producing a machining tool with the features of claim 16 as well as a method for producing a machining tool with the features of claim 17. Advantageous or preferred further developments are a subject matter of dependent claims.

A machining tool can comprise a shaft extending along a tool axis, a cutting head axially adjoining the shaft and an internal cooling lubricant channel system formed from a centrally running inlet channel, which leads from an inlet opening at the shaft end in the direction of the cutting head all the way to a branch point, which lies at a defined axial distance from the inlet opening, at least one outlet channel running in a decentralized manner, which leads to an outlet opening on the cutting head front side, and a branch channel running in a straight line, which branches off from the inlet channel at the branch point and which leads to the outlet channel at a defined angle. A cross sectional surface of the at least one branch channel, which is projected along the at least one branch channel in the direction of the shaft end, can lie completely within the inlet opening.

The machining tool can be any tool, which carries out a machining of a workpiece by means of one or several cutting edges. The machining tool can in particular be a drilling or milling tool, which has one or several main cutting edges or front cutting edges. The shaft can serve the purpose of clamping the tool into a machine spindle in the usual manner. Expediently, a number of outlet cannels and branch channels corresponds to a number of cutting edges, which can be formed on the cutting head front side in order to ensure a reliable supply of the cutting edges with cooling lubricant.

According to the machining tool, a cross sectional surface of the at least one branch channel, which is projected along the at least one branch channel in the direction of the shaft end, can lie completely within the inlet opening. In other words, an imaginary extension of the at least one branch channel, which runs in a straight line, lies completely within the inlet opening. The at least one branch channel can thus be formed by means of a conventional manufacturing technique, e.g., drilling, milling or eroding, from a shaft-side end of the machining tool via the inlet opening and through the inlet channel. The machining tool can thus be produced in a simple and cost-efficient manner. It does not matter thereby, in which order the inlet channel, the at least one branch channel and the at least one outlet channel are formed. Depending on the length of the cutting head and of the shaft as well as the defined angle, at which the at least one branch channel branches off from the inlet channel at the branch point, the branch point can lie within the cutting head or within the shaft.

In a further embodiment, the machining tool is formed in one piece.

A one-piece formation of the machining tool, in particular of the cutting head and of the shaft, simplifies the production of the tool. The machining tool can be produced in a cost-efficient manner, for example from a tool blank. The one-piece design additionally increases the stability of the machining tool. Due to the fact that a cross sectional surface of the at least one branch channel, which is projected along the at least one branch channel in the direction of the shaft end, lies completely within the inlet opening, the internal cooling lubricant channel system, in particular the at least one branch channel, which runs in a straight line, can be produced in a simple and cost-efficient manner with conventional manufacturing methods even in the case of a one-piece design. Interfaces, which have to be sealed, are not created within the cooling lubricant channel system. The flow of the cooling lubricant is thus improved and pressure losses are minimized. It is also possible, however, that the machining tool is formed in one piece by means of an additive manufacturing method, e.g., 3D printing.

In an alternative embodiment, the machining tool is formed in two pieces.

A two-piece formation of the machining tool provides for an expedient and advantageous use of different materials for the cutting head and the shaft.

A machining tool can comprise a shaft extending along a tool axis, a cutting head attached to the shaft at a joining point and an internal cooling lubricant channel system formed from a centrally running inlet channel, which leads via a shaft-side channel section from an inlet opening at the shaft end all the way to a connection opening at the joining point and via a cutting head-side channel section from the connection opening all the way to a branch point in the cutting head, at least one outlet channel running in a decentralized manner, which leads to an outlet opening on the cutting head front side, and a branch channel running in a straight line, which branches off from the shaft-side inlet channel at the branch point and leads to the outlet channel at a defined angle. The branch point can lie at a defined axial distance from the connection opening and a cross sectional surface of the at least one branch channel, which is projected along the at least one branch channel in the direction of the shaft end, can lie completely within the connection opening.

The machining tool can be any tool, which carries out a machining of a workpiece by means of one or several cutting edges. The machining tool can in particular be a drilling or milling tool, which has one or several main cutting edges or front cutting edges. The shaft can serve the purpose of clamping the tool into a machine spindle in the usual manner. Expediently, a number of outlet cannels and branch channels corresponds to a number of cutting edges, which can be formed on the cutting head front side in order to ensure a reliable supply of the cutting edges with cooling lubricant.

According to the machining tool, a cross sectional surface of the at least one branch channel, which is projected along the at least one branch channel in the direction of the shaft end, can lie completely within the connection opening. In other words, an imaginary extension of the at least one branch channel, which runs in a straight line, lies completely within the connection opening, which is located at the joining point between cutting head and shaft. The at least one branch channel can thus be formed by means of a conventional manufacturing technique, e.g., drilling, milling or eroding, through the inlet channel. It does not matter thereby, in which order the inlet channel, the at least one branch channel and the at least one outlet channel are formed. The longitudinal section, which later faces the shaft to be attached, can subsequently be separated from the cutting head blank processed in this way at a point, which lies at an axial distance from the branch point, at which the at least one branch channel branches off from the inlet channel. The two-piece formation of the machining tool expediently provides for the use of different materials for cutting head and shaft. In the case of the described machining tool, the channel section of the cutting head-side inlet channel, the branch point, the at least one branch channel and the at least one outlet channel lie within the cutting head.

In a further embodiment, the inlet channel runs in a straight line, in particular axially along the tool axis.

The formation of the inlet channel in a straight line, in particular axially along the tool axis, can be produced in a simple manner by means of conventional manufacturing methods and is advantageous in terms of a high concentricity of the machining tool.

In a further embodiment, the at least one outlet channel runs in a straight line, in particular parallel to the tool axis.

The formation of the outlet channel in a straight line, in particular parallel to the tool axis, can be produced in a simple manner by means of conventional manufacturing methods. In terms of a high concentricity of the machining tool, the several outlet channels are arranged so as to be distributed evenly around the tool axis in the case of several outlet channels.

In an alternative embodiment, the at least one outlet channel runs helically.

The helical shape can ensure a turbulence in the cooling lubricant flow and can ensure that the cooling lubricant can reach cutting edges formed on the cutting head front side more efficiently, whereby a cooling effect can be improved. On the other hand, a turbulent cooling lubricant flow can further decrease the friction and can simplify the chip removal. The at least one outlet channel preferably coils around an axis running parallel to the tool axis.

In a further embodiment, a channel cross sectional surface of the at least one outlet channel or a sum of all channel cross sectional surfaces of the outlet channels corresponds to a channel cross sectional surface of the inlet channel.

It can be ensured by means of this design that an even flow is attained within the cooling lubricant channel system, in particular identical flow speeds within the channel system. The cutting edge or the cutting edges of the machining tool can consistently and reliably be supplied with cooling lubricant. The even flow of the cooling lubricant furthermore ensures a safe removal of the chips.

The shaft can be made of steel, in particular when the machining tool is formed in two pieces.

Due to its hardness, wear resistance and breaking strength as well as toughness, steel is suitable as cost-efficient material for the shaft, in particular for that section of the shaft, which can be clamped into a machine spindle.

Corresponding thereto, the cutting head can be made of solid carbide when the machining tool is formed in two pieces.

Due to its properties of a high hardness, high wear resistance, high heat resistance and low heat expansion, the use of solid carbide for the cutting head, in particular for the cutting edges of the cutting head, makes it possible to carry out sophisticated machining processes with simultaneously long service lives of the machining tool.

In a further embodiment, the cutting head has main cutting edges, secondary cutting edges, clamping grooves and free spaces and the at least one outlet opening lies at least partly in a free surface.

On the front side of the machining tool, the main cutting edges can extend in a known manner radially outwards from a transverse cutting edge all the way to a cutting edge corner and can transition into a secondary cutting edge at this point, which extends in a straight line or helically along a clamping groove in the direction of the shaft. Each main cutting edge can be formed by a cutting line of a chip surface transitioning into the clamping groove as well as a free surface. The number of outlet channels or outlet openings, respectively, preferably corresponds to the number of main cutting edges. When the outlet opening lies at least partly in the free surface, a chip formation taking place at the chip surface and a chip removal within the chip groove is hampered to a lesser extent. Advantageously, the outlet opening thus lies completely within the free surface.

In the case that the machining tool is formed in two pieces, the shaft can be soldered to the cutting head.

However, other alternative connecting methods are also possible, which provide for a reliable and permanent connection between cutting head and shaft as well as a sealing of the cooling lubricant channel system to the outside, for example a welded or adhesive connection.

In a further embodiment, the cutting head has a conical journal at its shaft-side end, and, at its head-side end, the shaft has a receiving cone, which receives the conical journal.

A surface pairing formed from journal and receiving cone simplifies a centering of the cutting head with respect to the shaft. Compared to a, for example, circular or circular ring-shaped joining point surface, a joining point surface of the cutting head at the shaft is larger, so that the reliability and stability of a connection between cutting head and shaft can be increased.

In a further embodiment, the at least one outlet channel extends axially through the entire cutting head, in particular through the entire machining tool.

Regardless of whether the machining tool is formed in one piece or two pieces, the production thereof is simplified when the at least one outlet channel extends axially through the entire cutting head, in particular through the entire machining tool because the at least one outlet channel can be formed in a simple manner with known production methods for forming through-holes in a cutting head blank or a machining tool formed in one piece. Chips or material residues remaining after the formation of the at least one outlet channel can be removed easily from the continuous outlet channel.

In an alternative embodiment, the at least one outlet channel and the branch channel leading to the outlet channel adjoin one another seamlessly.

The inlet channel and the at least one branch channel preferably also adjoin one another seamlessly. A closed cooling lubricant channel system can thus be formed, which, based on the machining tool, is open to the outside only at the inlet opening and at the outlet opening, whereby a constant consistent flow without pressure losses can be attained within the cooling lubricant channel system.

In a method for producing a machining tool according to one of the above aspects, the branch channel assigned to the at least one outlet channel can be drilled, eroded or milled into the shaft through the inlet opening and the inlet channel.

The machining tool can in particular be a machining tool, which is formed in one piece, wherein the inlet channel for forming the internal cooling lubricant channel system is formed first. The branch channel assigned to the at least one outlet channel is subsequently drilled, eroded or milled into the shaft through the inlet opening and the inlet channel. The outlet channel can already be present thereby or can be formed in the cutting head after the formation of the branch channel by means of a suitable method, e.g., drilling, milling or eroding. According to the machining tool, a cross sectional surface of the at least one branch channel, which is projected along the at least one branch channel in the direction of the shaft end, lies completely within the inlet opening. The at least one branch channel can thus be formed by means of a conventional manufacturing technique, such as drilling, milling or eroding, from a shaft-side end of the machining tool through the inlet opening and the inlet channel. The production method is thus simple and cost-efficient.

In a further method for producing a machining tool according to one of the above aspects, the branch channel assigned to the at least one outlet channel can be drilled, eroded or milled through the inlet channel in a cutting head blank starting at an outer circumferential side, a longitudinal section can be separated from the cutting head blank, which is processed in this way, for forming the joining point surface at the cutting head, and the shaft can be attached to the joining point surface of the cutting head formed in this way.

The machining tool is a machining tool formed in two pieces, wherein the inlet channel for forming the internal cooling lubricant channel system is formed first in the cutting head blank. The branch channel assigned to the at least one outlet channel is subsequently drilled, eroded or milled through the inlet channel, starting at an outer circumferential side. The outlet channel can already be present thereby in the cutting head blank or can be formed in the cutting head blank after the formation of the branch channel by means of a suitable method, e.g., drilling, milling or eroding. The two-piece formation of the machining tool expediently provides for the use of different materials for cutting head and shaft with simultaneously simple and cost-efficient production or formation of the internal cooling lubricant channel system. In the case of the described machining tool, the channel section of the cutting head-side inlet channel, the branch point, the at least one branch channel and the at least one outlet channel lie within the cutting head.

The above-discussed and further features will be explained in more detail below on the basis of the enclosed figures based on the example of two exemplary embodiments of a machining tool.

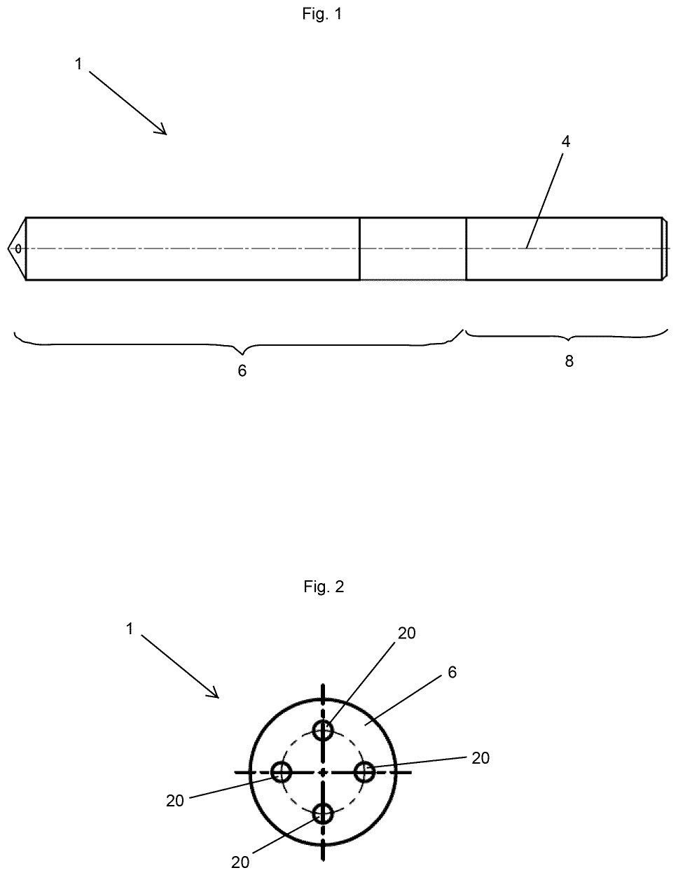

FIG. 1 shows a side view of a blank of a machining tool of a first embodiment,

FIG. 2 shows a front view of the blank from FIG. 1,

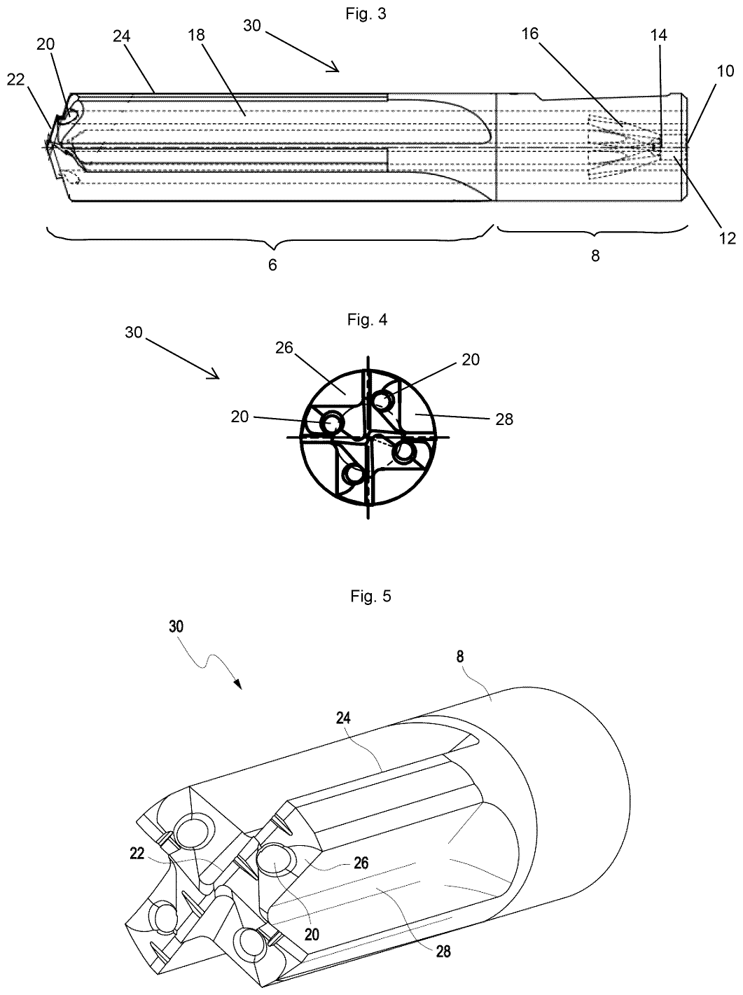

FIG. 3 shows a side view of the machining tool of the first embodiment,

FIG. 4 shows a front view of the machining tool of FIG. 3,

FIG. 5 shows a perspective view of the machining tool from FIG. 3,

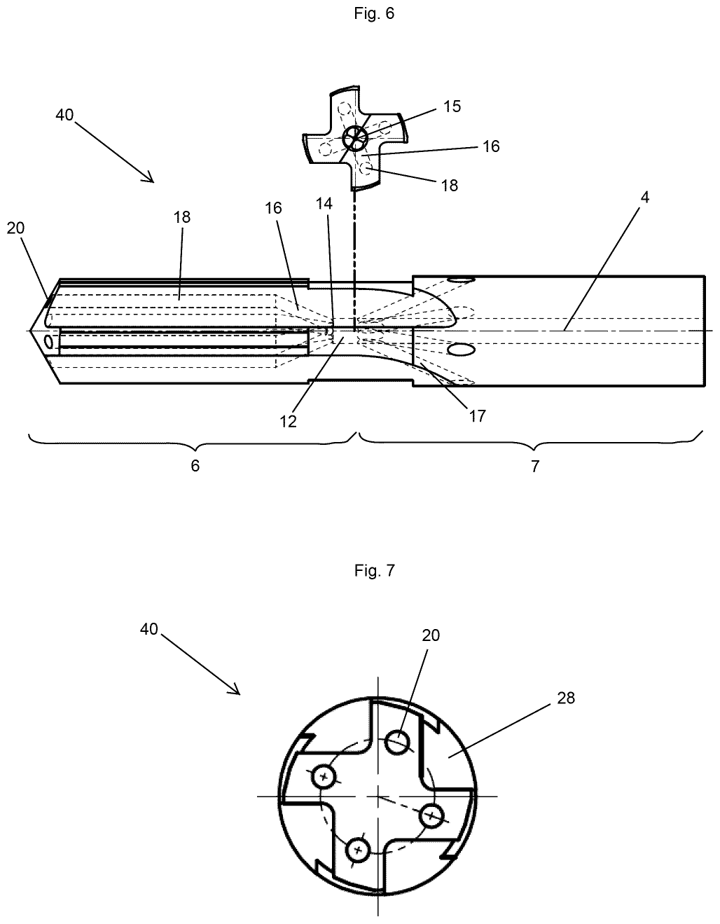

FIG. 6 shows a side view of a cutting head blank of a machining tool of a second embodiment as well as a sectional view at a joining point of the cutting head, which is to be formed,

FIG. 7 shows a front view of the cutting head blank of FIG. 6,

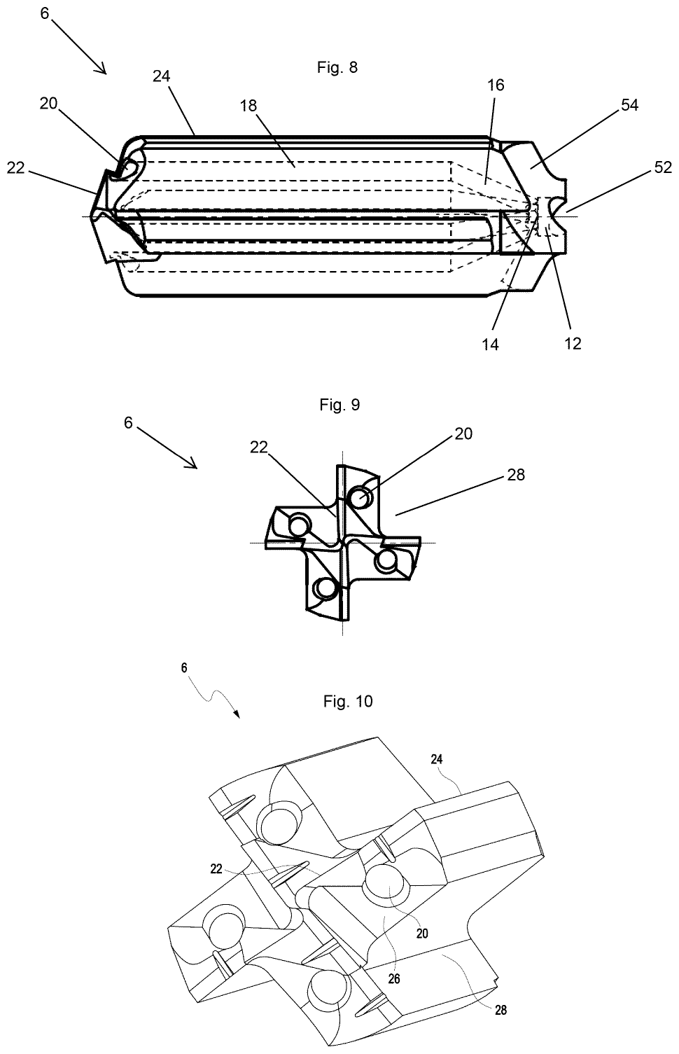

FIG. 8 shows a side view of a cutting head of the machining tool of the second embodiment,

FIG. 9 shows a front view of the cutting head of FIG. 8, and

FIG. 10 shows a perspective view of the cutting head of FIG. 8.

The figures are only of a schematic nature and serve only to understand the disclosure. The size ratios of the elements illustrated in the figures are adapted accordingly in order to be make it easier to understand the disclosure.

### First Embodiment

FIG. 1 to 5 show a machining tool 30 according to a first embodiment or a machining tool blank 1, respectively, for producing the machining tool 30. The machining tool 30 is formed in one piece and has a shaft 8, which extends along a tool axis 4, for clamping into a machine spindle, a cutting head 6 axially adjoining the shaft 8 and an internal cooling lubricant channel system. In the first embodiment, the machining tool 30 is embodied as drilling tool and has four stepped main cutting edges 22 at an end on the front side, which each extend radially outwards from a drill center all the way to a cutting edge corner and which transition into a secondary cutting edge 24, which extends axially in the direction of the shaft 8. Opposite to the direction of rotation of the drilling tool, a stepped free surface 26 adjoins each main cutting edge 22. Starting at each main cutting edge 22, a straight clamping groove 26 extends along the corresponding secondary cutting edge 24 in the direction of the shaft 8.

In the side view of FIG. 3, the cooling lubricant channel system is illustrated with dashed lines. Starting at an inlet opening 10 at the shaft-side end of the machining tool 30, an inlet channel 12, which runs centrally along the tool axis 4, leads in the direction of the cutting head 6 all the way to a branch point 14, which lies at a defined axial distance from the inlet opening 10. At the branch point 14, the inlet channel 12 splits into four branch channels 16, which run in a straight line at a defined angle to the tool axis 4. Each branch channel 16 ends in an outlet channel 18, which runs in a decentralized manner. The outlet channels 18 extend axially through the entire machining tool 30 and are distributed evenly around the tool axis 4. On the cutting head front side, each outlet channel 18 ends in an outlet opening 20, from which the cooling lubricant can escape from the cooling lubricant channel system and can serve the purpose of cooling and lubricating in particular the main cutting edges 22.

To produce the cooling lubricant channel system, the outlet channels 18 in the first embodiment are initially drilled, milled or eroded through the machining tool blank 1. The outlet openings 20 of the outlet channels 18 formed on the front side of the machining tool blank 1 can already be seen in FIG. 2. The central inlet channel 12 is drilled, milled or eroded from the shaft side of the machining tool blank 1 over a defined length all the way to the branch point 14, whereby the inlet opening 10 of the inlet channel 12 is formed. The branch channels 16 are subsequently drilled, milled or eroded through the inlet opening 10 and the inlet channel 12 into the shaft 8 all the way to the outlet channels 18. The inlet channel 12 is not further enlarged during the formation of the branch channels 16. As a result, a cross sectional surface of the branch channel 16, which is projected along each branch channel 16 in the direction of the shaft end, lies completely within the inlet opening 10. The branch channels 16 are fluidically advantageously aligned so that a transition, which is as seamless as possible, from the inlet channel 12 into the branch channels 16 results in the axial direction of the machining tool 30, viewed from the shaft end in the direction of the cutting head 6, at the branch point 14 between the branch channels 16. In other words, the branch channels 16 intersect at the branch point 14, so that the cooling lubricant flowing from the inlet channel 12 in the direction of the outlet channels 18 hits a very small surface, in particular an essentially punctiform impact point, of shaft material at the branch point 14 in the region of the tool axis 4 and flows into one of the branch channels 16 outside of the impact point.

The sum of the channel cross sectional surfaces of the outlet channels 18 as well as the sum of the channel cross sectional surfaces of the branch channels 16 corresponds to a channel cross sectional surface of the inlet channel 12. It can be ensured by means of this design that an even flow is attained within the cooling lubricant channel system, in particular identical flow speeds within the channel system. The main cutting edges 22 of the machining tool 30 can consistently and reliably be supplied with cooling lubricant.

As is shown in particular in FIG. 5, each outlet opening 20 lies completely within a stepped free surface 26, whereby a chip formation, which takes place on a chip surface, and a chip removal is not impeded in the clamping groove 28.

### Second Embodiment

FIG. 6 to 10 show the cutting head 6 of a machining tool according to a second embodiment or a cutting head blank 40, respectively, for producing the cutting head 6. Elements, which structurally and/or functionally correspond to elements of the first embodiment, are identified with the same reference numeral. In particular the differences compared to the first embodiment will be discussed below.

The machining tool according to the second embodiment is formed in two pieces, wherein only the cutting head 6 of the machining tool, which is produced from the cutting head blank 40 shown in FIGS. 6 and 7, is shown in FIG. 8 to 10. The cutting head blank 40 illustrated in FIG. 6 comprises the cutting head 6 as well as a longitudinal section 7 to be separated in the axial direction.

To produce the cooling lubricant channel system within the cutting head 6, the outlet channels 18 are initially drilled, milled or eroded in the form of blind holes from the tool front side into the cutting head blank 40 in the second embodiment. The outlet openings 20 of the outlet channels 18 formed on the front side of the cutting head blank 40 can already be seen in FIG. 7. The central inlet channel 12 is drilled, milled or eroded from the shaft side of the cutting head blank 40 over a defined length all the way to the branch point 14. Starting at an outer circumferential side, the branch channels 16 are subsequently drilled, milled or eroded through inlet channel 12 all the way to the outlet channels 18 (see the branch channel bore 17 in FIG. 6). In the second embodiment, a seamless connection or transition, respectively, results from the branch channels 16 into the outlet channels 18.

The longitudinal section 7 is separated from the cutting head blank 40, which is processed in this way, and the cutting head 6 shown in FIG. 8 is obtained. By means of the separation of the longitudinal section 7, a joining point 54 or joining point surface, respectively, with a connection opening 52 is formed within the inlet channel 12. The joining point 54 has the shape of a conical journal, which is received by a correspondingly formed receiving cone of a shaft when the cutting head 6 is attached to the shaft. As is furthermore shown in FIG. 8, the branch point 14 in the second embodiment lies at a defined axial distance from the connection opening 52, and a cross sectional surface of the branch channel 16, which is projected along the branch channel 16 in the direction of the shaft end, lies completely within the connection opening 52.

The branch channels 16 are fluidically advantageously aligned so that a connection or transition, respectively, which is as seamless as possible, from the inlet channel 12 into the branch channels 16 results in the axial direction of the machining tool, viewed from the shaft end in the direction of the cutting head 6, at the branch point 14 between the branch channels 16. In other words, the branch channels 16 intersect at the branch point 14, so that the cooling lubricant flowing from the inlet channel 12 in the direction of the outlet channels 18 hits a very small surface, in particular an essentially punctiform impact point, of shaft material at the branch point 14 in the region of the tool axis 4 and flows into one of the branch channels 16 outside of the impact point. The impact point is identified with reference numeral 15 in the sectional view illustrated on the top in FIG. 6 at the joining point 54 or connection opening 52 to be formed, respectively.

### Alternative Embodiments

In the first embodiment, the machining tool is formed in one piece. However, the machining tool can also be formed in two pieces and can have a joining point between cutting head and shaft. The outlet channels furthermore extend through the entire machining tool. Alternatively, it is also possible that each outlet channel extends starting at the tool front side all the way to an assigned branch channel and seamlessly adjoins the branch channel.

In the second embodiment, the branch channels seamlessly adjoin the outlet channels. However, the outlet channels can also extend through the entire cutting head.

### LIST OF REFERENCE NUMERALS

1 machining tool blank
4 tool axis
6 cutting head
7 longitudinal section to be separated
8 shaft
10 inlet opening
12 inlet channel
14 branch point
15 impact point
16 branch channel
17 branch channel bore
18 outlet channel
20 outlet opening
22 main cutting edge
24 auxiliary cutting edge
26 free surface
28 clamping groove
30 machining tool
40 cutting head blank
52 connection opening
54 joining point

1. A machining tool with a shaft extending along a tool axis, a cutting head axially adjoining the shaft and an internal cooling lubricant channel system formed from a centrally running inlet channel, which leads from an inlet opening at the shaft end in the direction of the cutting head all the way to a branch point, which lies at a defined axial distance from the inlet opening, at least one outlet channel running in a decentralized manner, which leads to an outlet opening on the cutting head front side, and a branch channel running in a straight line, which branches off from the inlet channel at the branch point and which leads to the outlet channel at a defined angle, characterized in that
a cross-sectional surface of the at least one branch channel, which is projected along the at least one branch channel in the direction of the shaft end, lies completely within the inlet opening.

2. The machining tool according to claim 1, wherein the machining tool (30) is formed in one piece.

3. The machining tool according to claim 1, wherein the machining tool is formed in two pieces.

4. A machining tool with a shaft extending along a tool axis, a cutting head attached to the shaft at a joining point and an internal cooling lubricant channel system formed from a centrally running inlet channel, which leads via a shaft-side channel section from an inlet opening at the shaft end all the way to a connection opening at the joining point and via a cutting head-side channel section from the connection opening all the way to a branch point in the cutting head, at least one outlet channel running in a decentralized manner, which leads to an outlet opening on the cutting head front side, and a branch channel running in a straight line, which branches off from the shaft-side inlet channel at the branch point and leads to the outlet channel at a defined angle, wherein:
the branch point lies at a defined axial distance from the connection opening, and
a cross-sectional surface of the at least one branch channel, which is projected along the at least one branch channel in the direction of the shaft end, lies completely within the connection opening.

5. The machining tool according to claim 1, wherein the inlet channel runs in a straight line, in particular axially along the tool axis.

6. The machining tool according to claim 1, wherein the at least one outlet channel runs in a straight line, in particular parallel to the tool axis. cm 7. The machining tool according to claim 1, wherein the at least one outlet channel runs helically.

8. The machining tool according to claim 1, wherein a channel cross sectional surface of the at least one outlet channel or a sum of all channel cross sectional surfaces of the outlet channels corresponds to a channel cross sectional surface of the inlet channel.

9. The machining tool according to claim 1, wherein the shaft is made of steel.

10. The machining tool (30) according to claim 1, wherein the cutting head is made of solid carbide.

11. The machining tool according to claim 1, wherein the cutting head has main cutting edges, secondary cutting edges, clamping grooves and free spaces and the outlet opening of the at least one outlet channel lies at least partly in a free surface.

12. The machining tool according to claim 1, wherein the shaft is soldered to the cutting head.

13. The machining tool according to claim 4, wherein the cutting head has a conical journal at its shaft-side end, and, at its head-side end, the shaft has a receiving cone, which receives the conical journal.

14. The machining tool according to claim 1, wherein the at least one outlet channel extends axially through the entire cutting head in particular through the entire machining tool.

15. The machining tool according to claim 1, wherein the at least one outlet channel and the branch channel leading to the outlet channel adjoin one another seamlessly.

16. A method for producing a machining tool according to claim 1, wherein the branch channel assigned to the at least one outlet channel is drilled, eroded or milled into the shaft through the inlet opening and the inlet channel.

17. A method for producing a machining tool according to claim 4, wherein:
the branch channel assigned to the at least one outlet channel is drilled, eroded or milled through the inlet channel in a cutting head blank starting at an outer circumferential side,
a longitudinal section is separated from the cutting head blank which is processed in this way, for forming the joining point surface at the cutting head, and
the shaft is attached to the joining point surface of the cutting head formed in this way.
